(19) United States
(12) Patent Application Publication
(10) Pub. No.: US 2018/0303268 A1
(43) Pub. Date: Oct. 25, 2018

(54) CRISPING WAND SYSTEM AND METHOD

(71) Applicant: Darlene Suzanne Townsend, Fort Saskatchewan (CA)

(72) Inventor: Darlene Suzanne Townsend, Fort Saskatchewan (CA)

(21) Appl. No.: 15/495,387

(22) Filed: Apr. 24, 2017

(51) Int. Cl. A47J 27/00; F24H 3/04; A23L 5/10; A47J 36/32

(52) U.S. Cl. CPC A47J 27/004; F24H 3/0423; A23V 2002/00; A47J 27/002; A47J 36/32; A23L 5/15

(57) ABSTRACT

A crisping wand system and method for crisping food on a counter top. The crisping wand includes a heater head including a heating assembly and a handle including a power port. The heating assembly has a support structure, a protective grate, a heating element, and a blower fan that work together in functional combination to project heated air onto and crisp food on a surface such as a countertop. The heater head also includes a user interface that enables a user to program the heating element and blower fan to project heated air at a preset temperature as a means for heating food. The crisping wand creates a portable device that is an easy way to crisp food on a counter top without having to use an oven broiler which may result in burning food.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of food and beverages apparatuses of existing art and more specifically relates to baking; roasting; grilling; frying using a crisping wand system.

### 2. DESCRIPTION OF RELATED ART

Certain foods are more appealing when heated to a desired level of crispness. Microwave ovens do not brown nor crisp foods in a manner that a heated element does. An oven broiler is often used to crisp foods. There exists a need to eliminate the need to use the broil function in the oven to reduce the risk of burning it under the broiler element. There also exists a need to cook small portions of food on a counter top such as steak, bacon or any food that one might normally turn on their oven broil function.

U.S. Pat. No. 6,725,764 to Sherwin relates to a method and apparatus for cooking poultry and fowl. The described method and apparatus for cooking poultry and fowl includes a segmented elongate, hollow convection pipe formed with an angled mid portion having a removable closed piercing cap or tip for piercing through the body cavity of stuffed poultry during cooking and preparation to cooking the closed end prevents dressing or stuffing from clogging the pipe when the stuffing is pierced by the tip of the hollow convection pipe. The tip is then removed for convection cooking. Each segment and the piercing cap or tip has a locking connection to enable the convection pipe segments to be securely locked together. The convection pipe is provided in plural individual sections of tubing that are serially joined in end-to-end relation. Overall length of the pipe can be adjusted by connecting greater or fewer numbers of sections of tubing, as required. Overall cooking time of both the poultry and the stuffing is more uniform and reduced as a result of simultaneous cooking from the inside as well as the outside. A method is provided for using the convection pipe to safely, quickly pierce the pre-stuffed turkey and then uniformly cook a raw, stuffed poultry

### BRIEF SUMMARY OF THE INVENTION

In view of the foregoing disadvantages inherent in the known baking; roasting; grilling; frying means art, the present disclosure provides a novel crisping wand system and method. The general purpose of the present disclosure, which will be described subsequently in greater detail, is to provide a crisping wand system and method for efficiently preparing such foods, using a hand held, lightweight electric broiler.

A crisping wand system and method is disclosed herein. The crisping wand system and method includes a heater head including a heating assembly and a handle including a power port. The heating assembly has a support structure, a protective grate, a heating element, and a blower fan that work together in functional combination to project heated air onto and crisp food on a surface such as a countertop. The heater head also includes a user interface that enables a user to program the heating element and blower fan to project heated air at a preset temperature as a means for heating food.

According to the preferred embodiment, a crisping wand method of use is also disclosed herein. The crisping wand method of use includes the steps of plugging the power port of the crisping wand assembly into a power supply, activating the crisping wand assembly through the user interface, holding the crisping wand assembly a specified distance from food, and crisping the food to the desired consistency. Further steps in the method of use may include the steps of unplugging the power port and washing the crisping wand assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a crisping wand, constructed and operative according to the teachings of the present disclosure.

FIG. 1 is a perspective view of the crisping wand system and method during an ‘in-use’ condition, according to an embodiment of the disclosure.

FIG. 2 is a perspective view of the crisping wand system and method of FIG. 1, according to an embodiment of the present disclosure.

FIG. 3 is a perspective view of the crisping wand system and method of FIG. 1, according to an embodiment of the present disclosure.

FIG. 4 is a perspective view of the crisping wand system and method of FIG. 1, according to an embodiment of the present disclosure.

FIG. 5 is a flow diagram illustrating a method of use for a crisping wand, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a baking, roasting, grilling, frying, or broiling means and more particularly to a crisping wand as used to improve the crisping of food positioned on a surface such as a countertop.

Generally, the crisping wand described is used to crisp cheese on casseroles, nachos or various foods that might require additional crisping after being cooked/heated in another device. The crisping wand simplifies the crisping process by eliminating the need to turn on the broil function in the oven as using the present invention a user can simply and easily crisp food on the countertop without the risk of burning it under the broiler element. The crisping wand draws less than 1500 W and helps to reduce electricity consumption. It may also be used to cook small portions of food such as steak or bacon or any food that one might normally turn on their oven broil function for. The crisping wand projects heated air that may be useful in other applications such as melting solder, heat shrink, glue, ice, or plastic, and other such applications.

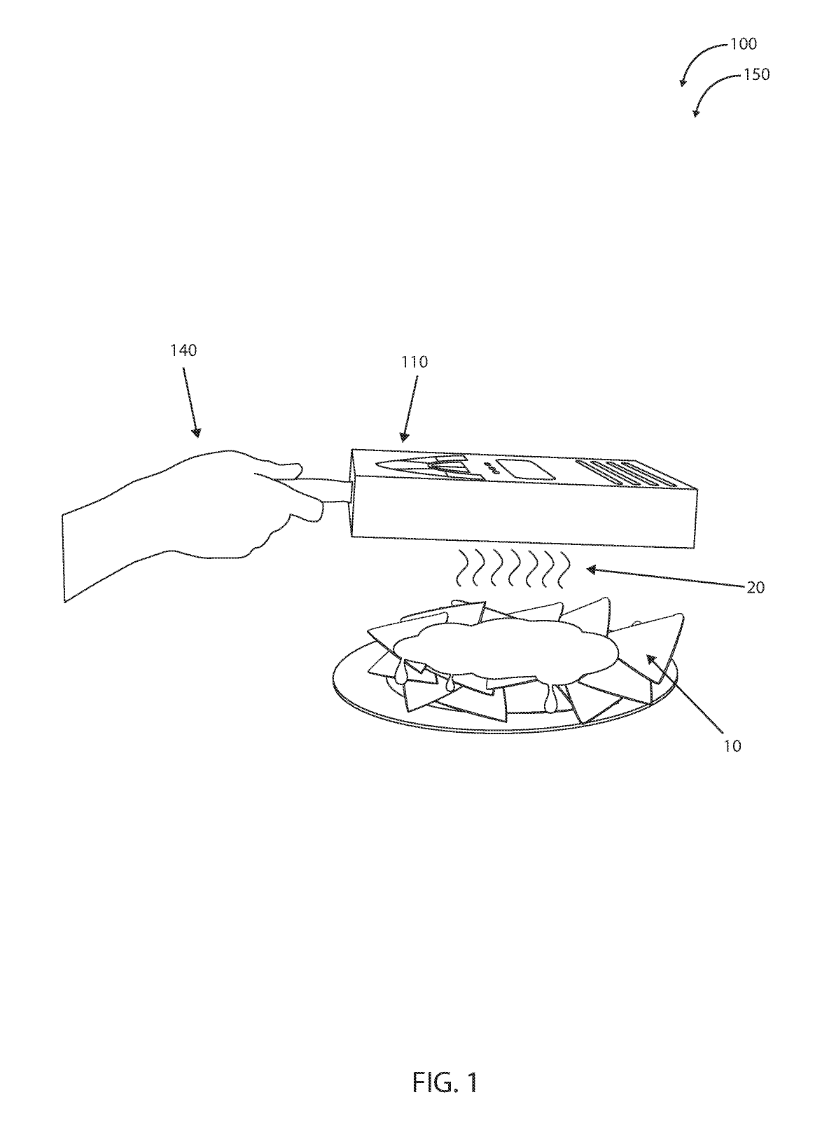

Referring now more specifically to the drawings by numerals of reference, there is shown in FIGS. 1-4, various views of a crisping wand system and method 100. FIG. 1 shows a crisping wand 110 during an ‘in-use’ condition 150, according to an embodiment of the present disclosure. Here, the crisping wand 110 may be beneficial for use by a user 140 to crisp food 10 on a countertop by propelling heated air 20.

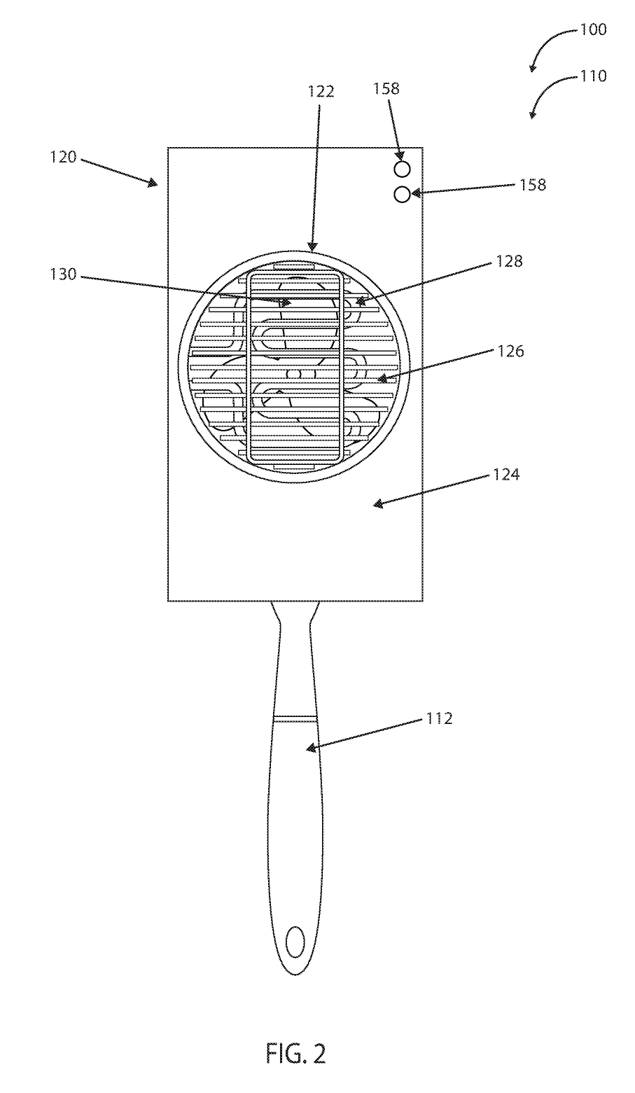

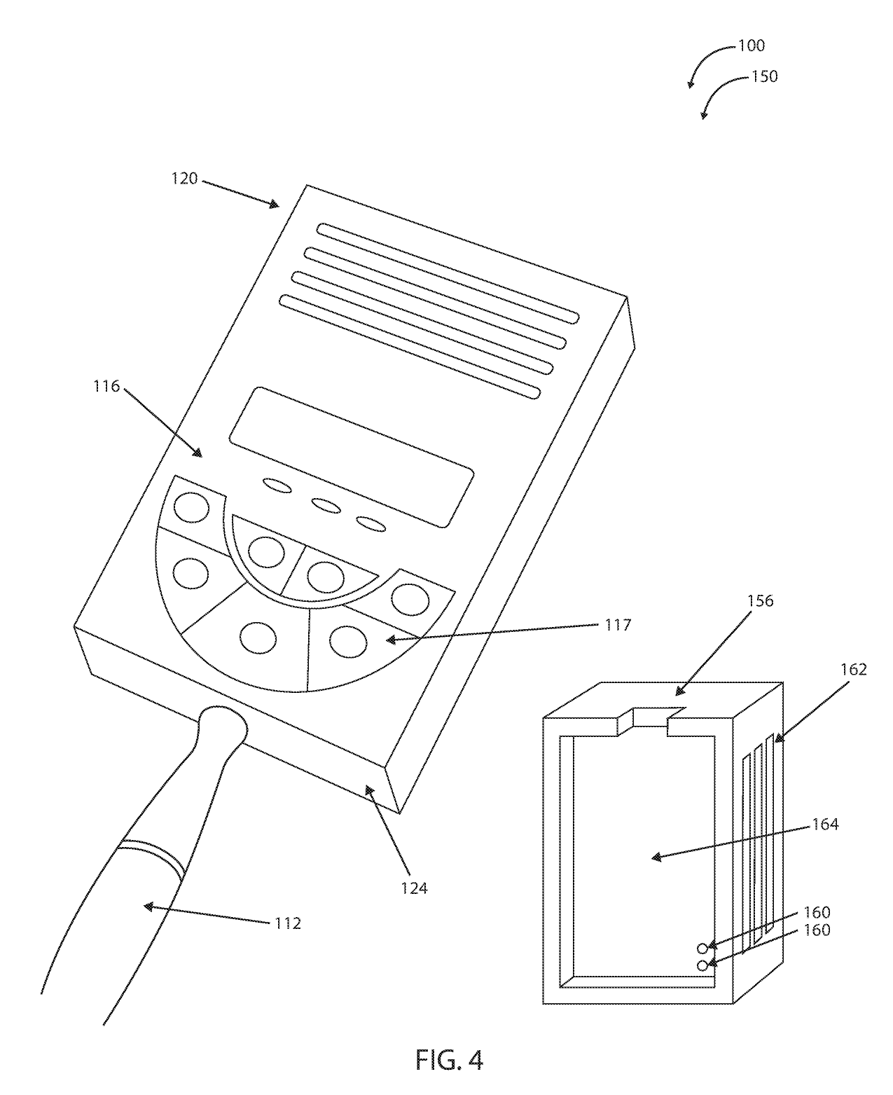

FIG. 2 shows a perspective view of the crisping wand system and method of FIG. 1, according to an embodiment of the present disclosure. According to this embodiment, the crisping wand system and method 100 may include a handle 112 and heater head 120 including a support structure 124 that are rigidly coupled into a single structure that is configured for hand held use. Heater head 120 has heating assembly 122 having protective grate 126 configured for shielding food 10 and user 140 (FIG. 1) from blower fan 130 and heating element 128. Heating element 128 heats incoming air that is then projected onto food 10 by blower fan 130 in functional combination to crisp food 10. In alternate embodiments, heater head 120 has automatic shutoff trigger receptacle 158 that is electrically coupled to heating element 128 and is configured to shut off electricity to heating element 128 when triggered by contacting automatic shutoff trigger activator 160 on heat rest 156 (FIG. 4).

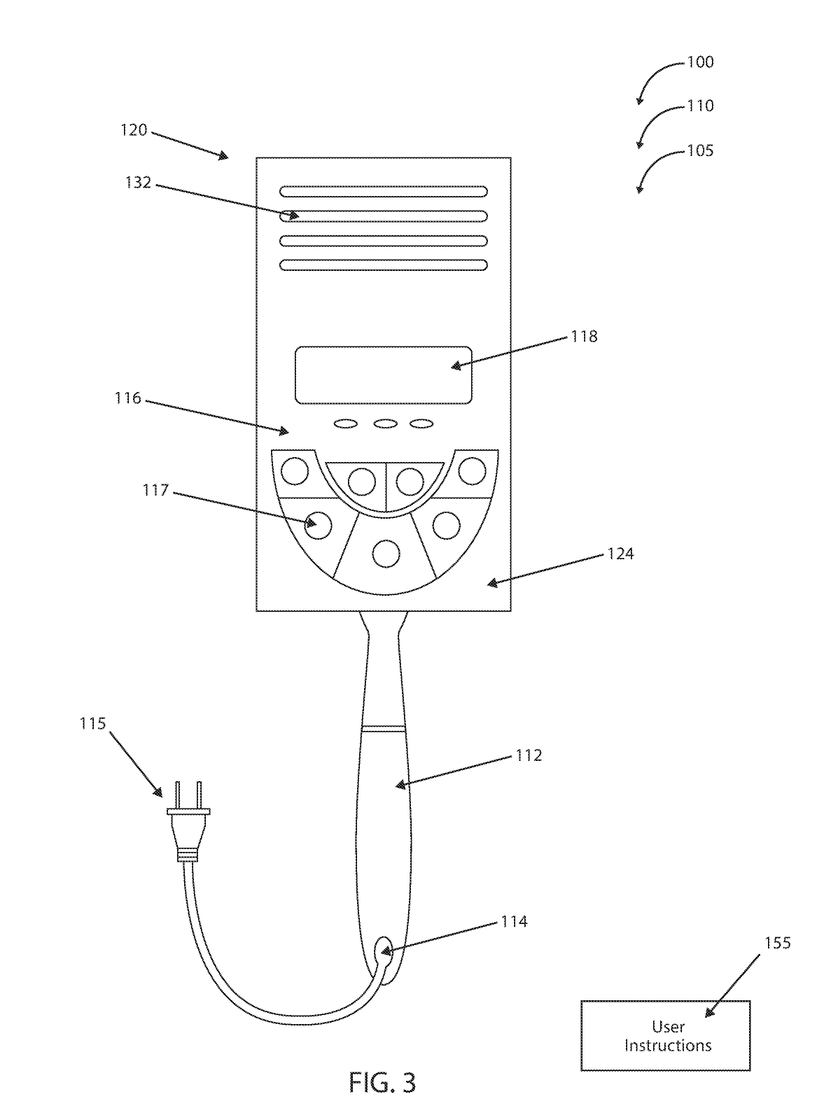

FIG. 3 is a perspective view of the crisping wand system and method 100 of FIG. 1, according to an embodiment of the present disclosure. As above, the crisping wand system and method 100 may include a handle 112 having a power port 114 and heater head 120 including a support structure 124, having air vent 132, and a user interface 116. Heated air 20 (FIG. 1) is drawn through air vent 132 by blower fan 130 (FIG. 2). Referring further to FIG. 3, according to this embodiment, the crisping wand system and method 100 may be arranged as a kit 105. In particular, the crisping wand system and method 100 may further include a set of instructions 155. The instructions 155 may detail functional relationships in relation to the structure of the crisping wand system and method 100 (such that the crisping wand system and method 100 can be used, maintained, or the like, in a preferred manner).

FIG. 4 is a perspective view of the crisping wand system and method 100 of FIG. 1, according to an embodiment of the present disclosure. As above, the crisping wand system and method 100 may include a heater head 120 including a support structure 124, having user interface 116. User interface 116 has display 118 for settings entered into data entry keyboard 117. In alternate embodiments, heater head 120 has automatic shutoff trigger receptacle 158 (FIG. 2) that is electrically coupled to heating element 128 and is configured to shut off electricity to heating element 128 when triggered by contacting automatic shutoff trigger activator 160 on heat rest 156 when crisping wand 110 is laid in recessed cradle 164. Heat rest 156 has heat rest vents 162 configured to allow cooling ventilation to heater head 120.

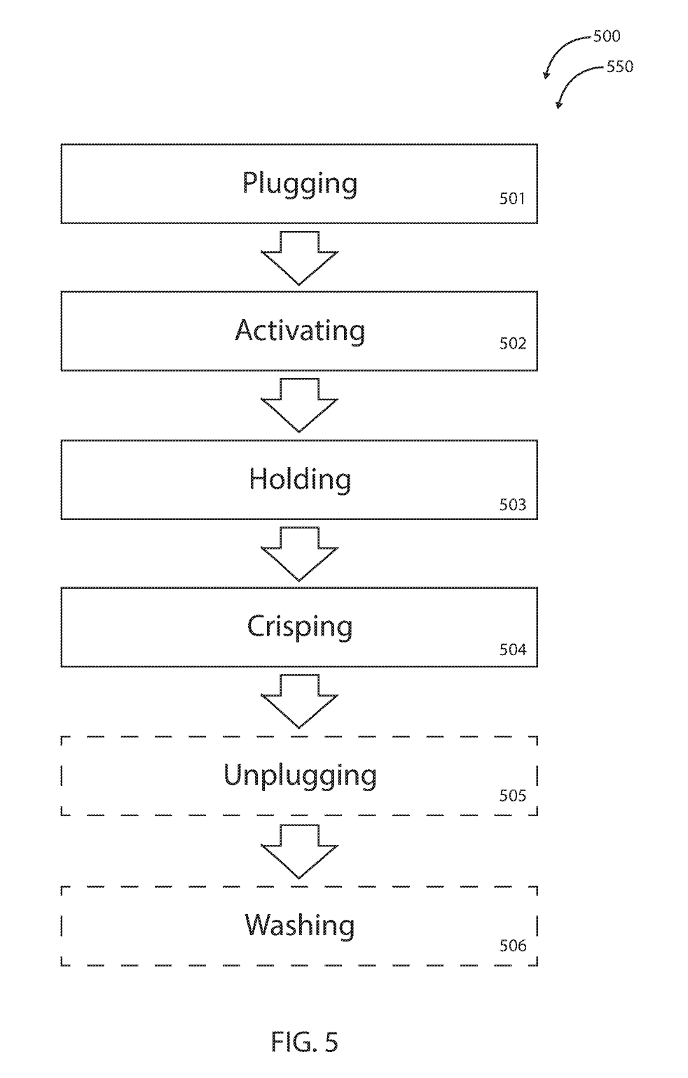

FIG. 5 is a flow diagram illustrating a method of use for the crisping wand system and method 100, according to an embodiment of the present disclosure. In particular, the method of use 500 may include one or more components or features of the crisping wand system and method 100 as described above. As illustrated, the method of use 500 may include the steps of: step one 501, plugging power port 114 of the crisping wand 110 into power cord 115; step two 502, activating crisping wand 110 through data input keyboard 117; step three 503, holding the crisping wand 110 a specified distance from food 10; and step four 504, crisping food 10 to the desired consistency.

The method for crisping food 500 may further include the steps of: step five 505, unplugging power port 114 of the crisping wand 110 from power cord 115 and step six 506, washing crisping wand 110.

It should be noted that steps 505 and 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for crisping (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A crisping wand system and method of use, the crisping wand system comprising:
a handle including;
a power port;
a heater head including;
a heating assembly having;
a support structure having;
air vents;
a protective grate;
a heating element; and
a blower fan;
a user interface having;
a data entry keyboard, and
a display;
wherein the heater head is rigidly coupled to the handle;
wherein the protective grate, heating element, and blower fan are rigidly coupled and supported by the support structure;
wherein the heating element, blower fan, user interface, and power port are electrically coupled; and
wherein the user interface programs the heating element and blower fan to project heated air at a preset temperature as a means for heating food.

2. The crisping wand system and method of use of claim 1, wherein the method of use includes crisping food by projecting the heated air onto the food.

3. The crisping wand system and method of use of claim 1, wherein a maximum power drawn is 1500 watts.

4. The crisping wand system and method of use of claim 1, wherein the power port accepts a plug and cord assembly for a typical household AC current.

5. The crisping wand system and method of use of claim 4, wherein the plug and cord assembly is removable for easy cleaning of the crisping wand assembly.

6. The crisping wand system and method of use of claim 1, wherein the crisping wand system has an automatic shutoff trigger receptacle.

7. The crisping wand system and method of use of claim 1, wherein the crisping wand system and method of use is configured for melting heat shrink tubing.

8. The crisping wand system and method of use of claim 6, wherein the crisping wand system has a heat rest having a recessed cradle and an automatic shutoff trigger activator.

9. The crisping wand system and method of use of claim 1, wherein the crisping wand system and method of use is configured for melting ice.

10. The crisping wand system and method of use of claim 1, wherein the power port accepts an input from an energy storage element.

11. The crisping wand system and method of use of claim 1, wherein the crisping wand system and method of use is configured for thawing food.

12. The crisping wand system and method of use of claim 1, wherein the crisping wand system and method of use is configured for drying an object.

13. The crisping wand system and method of use of claim 1, wherein the crisping wand system and method of use is configured for activating glue.

14. The crisping wand system and method of use of claim 1, wherein the crisping wand system and method of use is configured for melting plastic.

15. The crisping wand system and method of use of claim 1, wherein the crisping wand system and method of use is configured for reheating food.

16. The crisping wand system and method of use of claim 1, wherein the crisping wand system and method of use is configured for melting cheese.

17. A crisping wand system and method of use, the crisping wand system comprising:
a handle including;
a power port;
a heater head including;
a heating assembly having;
a support structure having;
air vents;
a protective grate;
a heating element; and
a blower fan;
a user interface having
a data entry keyboard, and
a display;
wherein the heater head is rigidly coupled to the handle;
wherein the protective grate, heating element, and blower fan are rigidly coupled and supported by the support structure;
wherein the heating element, blower fan, user interface, and power port are electrically coupled;
wherein the user interface programs the heating element and blower fan to project a preset temperature as a means for heating food;
wherein the method of use includes crisping food by projecting the heat on the food;
wherein a maximum power drawn is 1500 watts;
wherein the power port accepts a plug and cord assembly for a typical household AC current; and
wherein the plug and cord assembly is removable for easy cleaning of the crisping wand assembly.

18. The crisping wand system and method of use of claim 17, further comprising set of instructions; and wherein the crisping wand system and method of use is arranged as a kit including the crisping wand.

19. A crisping wand system and method of use, the method comprising the steps of:
plugging a power port of the crisping wand assembly into a power supply;
activating the crisping wand assembly through a data input keyboard;
holding the crisping wand assembly a specified distance from food; and
crisping the food to a desired consistency.

20. The method of claim 19, further comprising the steps of:
unplugging the power port; and
washing the crisping wand assembly.
